(19) United States
(12) Patent Application Publication
(10) Pub. No.: US 2024/0148023 A1
(43) Pub. Date: May 9, 2024

(54) METHODS OF BINDING INGREDIENTS OF MEAT ANALOG PRODUCTS

(71) Applicant: Archer Daniels Midland Company, Decatur, IL (US)

(72) Inventors: Jinsha Li, Decatur, IL (US); Wei Li, Decatur, IL (US); Ross Wyatt, Decatur, IL (US)

(21) Appl. No.: 18/549,097

(22) PCT Filed: Mar. 7, 2022
(86) PCT No.: PCT/US2022/019172

§ 371 Date: Sep. 5, 2023

Related U.S. Application Data
(60) Provisional application No. 63/157,146, filed on Mar. 5, 2021.

(51) Int. Cl. A23J 3/22; A23L 29/206; A23L 29/212; A23L 29/244; A23L 29/269

(52) U.S. Cl. CPC A23J 3/227; A23L 29/206; A23L 29/212; A23L 29/244; A23L 29/27; A23L 29/271; A23L 29/272

(57) ABSTRACT

Methods of binding ingredients of a meat alternative product are disclosed. One method comprises mixing a first hydrocolloid and a second hydrocolloid with a protein, thus producing the meat alternative product and forming the meat alternative product to a desired shape. Another method includes mixing a first hydrocolloid, a second hydrocolloid, and a protein, thus producing the meat alternative product and hydrating the meat alternative product. Products produced by the methods are also disclosed.

### TECHNICAL FIELD

The present invention relates generally to meat analogs. More particularly, the present invention relates to an improved binder system used to bind ingredients in a meat alternative product.

### BACKGROUND OF THE INVENTION

Demands for meat consumption have been decreasing and demands for meat substitutes has been increasing. The growing demand for meat substitutes has resulted in a number of new meat alternatives on the market. However, the meat alternative market has challenges in achieving texture, flavor, clean-label ingredients, and nutritional value.

Most commercially available meat analogue products use methylcellulose and modified starch as binders. Methylcellulose is produced from cellulose treated with methyl chloride in a caustic solution to produce a white, odorless powder. The methylcellulose is soluble in cold water and forms a gel upon heating to hold textured pieces in plant-based meat products together during cooking. However, the methylcellulose gel is thermo-reversible and returns to a viscous solution after cooling.

Due to the highly processed nature of the methylcellulose, achieving a clean label in food products using methylcellulose is problematic.

Attempts to create such a clean-label binder for use in meat substitutes have been made. One attempt is a citrus fiber/alginate gel, but this product requires more than 20 minutes to set and heat-stability may be an issue. Another attempt using carrageenan and konjac in combination to deliver a firm and slicable structure has been tried. However, such solution appears to function well when cold, but is unable to deliver acceptable functions such as juiciness, softness, and succulence when heated. As of the filing date of this application, methylcellulose appears to be the best option for binding pieces in meat alternative products.

Thus, needs exist in the meat alternative business for a clean-label product that is able to mimic the functionality of methylcellulose.

### BRIEF SUMMARY OF THE INVENTION

In each of its various embodiment, the present invention fulfills these needs and discloses a clean-label product that is able to function as a binder in meat alternative products.

In one embodiment, a method of binding ingredients of a meat alternative product comprises mixing a first hydrocolloid and a second hydrocolloid with a protein, thus producing the meat alternative product and forming the meat alternative product to a desired shape.

In another embodiment, a meat alternative product comprises a first hydrocolloid, a second hydrocolloid, and a plurality of protein particles. Upon hydration, the first hydrocolloid and the second hydrocolloid adhere at least a portion of the plurality of the protein particles together, and provide structure to the meat alternative product.

In a further embodiment, a method of binding ingredients of a meat alternative product includes mixing at least one hydrocolloid and a protein, thus producing the meat alternative product and hydrating the meat alternative product.

### BRIEF DESCRIPTION OF THE DRAWINGS

FIG. 1 shows the storage modulus (G′) of various embodiments of gels of the present invention as compared to gels produced with carboxymethylcellulose.

FIG. 2 shows various plant based patties and hamburgers produced with various embodiments of gels of the present invention.

FIG. 3 shows a spider web of plant based patties and hamburgers produced with various embodiments of gels of the present invention.

FIG. 4 shows the shear force modulus of patties produced without various embodiments of gels of the present invention compared to real beef burger.

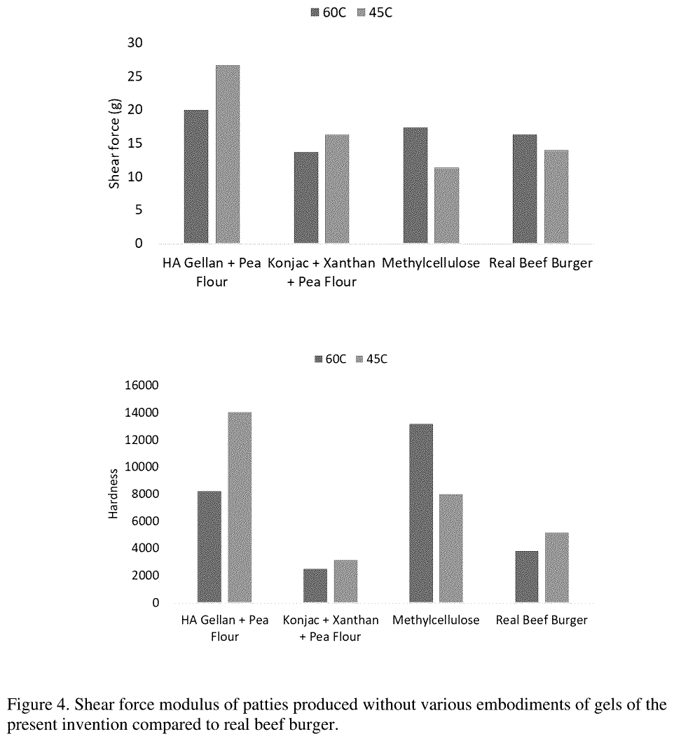

### DETAILED DESCRIPTION OF THE INVENTION

In one embodiment, a method of binding ingredients of a meat alternative product includes mixing a first hydrocolloid and a second hydrocolloid with a protein, thus producing the meat alternative product. The meat alternative product is formed into a desired shape.

The meat alternative product may be a plant-based burger patty and include, without limitation, a protein, a fat, flavors, colors, and other ingredients known to be used in plant-based meat analog products.

In various embodiments, the first hydrocolloid and the second hydrocolloid may be mixed with water to form a hydrocolloid solution. The method may further include mixing the protein with water, thus forming a hydrated protein. The hydrocolloid solution and the hydrated protein may also be mixed with the water separately, wherein the hydrocolloid solution and the hydrated protein are mixed together. The method may further include heating the hydrocolloid solution. The method may also include mixing a cross-linking agent with the hydrocolloid solution.

The method may also include mixing the first hydrocolloid, the second hydrocolloid, and the protein with water, thus forming the meat alternative product. A water binding agent and/or a fiber may also be mixed with the first hydrocolloid, the second hydrocolloid, and the protein.

In other embodiments, the first hydrocolloid and the second hydrocolloid may be independently selected from the group consisting of psyllium husk, gellan gum, curdlan gum, xanthan gum, a starch, and combinations of any thereof. The gellan gum may be a low-acyl gellan gum. In an embodiment, the first hydrocolloid may be konjac gum and the second hydrocolloid may be xanthan gum.

The protein may be a textured protein. The protein may also be selected form the group consisting of a soy protein, an edible bean protein, a pea protein, a black eyed pea protein, a lentil protein, a fava bean protein, a sunflower protein, a chickpea protein, a quinoa protein, a chia protein, a cranberry protein, a lupin protein, an amaranth protein, a sacha inchi protein, an oat protein, a peanut protein, a corn protein, a sorghum protein, a teff protein, a sesame protein, an algal protein, a spirulina protein, a wheat protein, a fungal protein, a mycelium based protein, a fermented meat protein, a bacterial protein, a cultured meat, a cell-based protein, an emulsified protein, and combinations of any thereof.

In the various embodiments, the first hydrocolloid and the second hydrocolloid may be present in the meat alternative product at an amount of 1-10%. In another embodiment, the first hydrocolloid may be present in the meat alternative product at an amount of 1-4%, the second hydrocolloid may be present in the meat alternative product at an amount of 1-4%, or a combination thereof.

In another embodiment, the first hydrocolloid may be present in the meat alternative product at an amount of 0.5-3%, the second hydrocolloid is present in the meat alternative product at an amount of 0.5-3%, or a combination thereof.

In a further embodiment, the methods of the present invention or the meat alternative products of the present invention may include incorporating methylcellulose with the hydrocolloids, such as in amounts of 1-10%.

In a further embodiment, an oil or fat, or emulsions thereof may also be incorporated into the meat alternative product.

In a further embodiment, a meat alternative product includes a first hydrocolloid, a second hydrocolloid, and a plurality of protein particles. Upon hydration, the first hydrocolloid and the second hydrocolloid adhere at least a portion of the plurality of the protein particles together, and provide structure to the meat alternative product.

The first hydrocolloid and the second hydrocolloid of the meat alternative product may be independently selected from the group consisting of psyllium husk, gellan gum, and curdlan gum. The meat alternative product may further include a cross-linking agent and/or a water binding agent.

In a further embodiment, a method of binding ingredients of a meat alternative product includes mixing a first hydrocolloid, a second hydrocolloid, and a protein, thus producing the meat alternative product. The meat alternative product is hydrated. The hydrated, meat alternative product may be molded to a desired shape. The hydrated, meat alternative product may further be cooked.

A starch or fiber may be missed with the meat alternative product to absorb excess moisture. Additionally, a salt, a flavor, or a combination thereof may be missed with the meat alternative product. In an embodiment, the first hydrocolloid is xanthan gum and the second hydrocolloid is Konjac gum. The starch or may a pre-gel starch or flour and may originate from a pea. The pea flour or starch may be thermally processed such as by extrusion. The starch, pre-gel starch, or flour may have a composition of about 6.5-8.5% of crude protein, about 65-70% of starch, and/or about 10-16% of fiber.

A product produced by any of the methods of the present invention may also be obtained.

### Example 1

In order to achieve the functionality of methylcellulose in alternative meat patties, a variety of hydrocolloids and/or their blends were evaluated with a thermal test. The thermal test mimics the temperature changes that would occur during alternative meat patty forming, cooking, and cooling. Typically, patties are cooked on a flat top grill at about 325-375° F. or a char broiler at about 450-500° F. until the internal temperature of the patty reaches about 165° F. Accordingly, the thermal test heated the gum(s) to about 75° C. and cooled to about 55° C. to mimic cooking and consumption temperatures.

Five different combinations of hydrocolloids were blended together and evaluated as a heat-stable binder in the amounts listed in Table 1. The percent amounts of Table 1 are the percent of the hydrocolloid in water. Methylcellulose (MC) is shown in the second column.

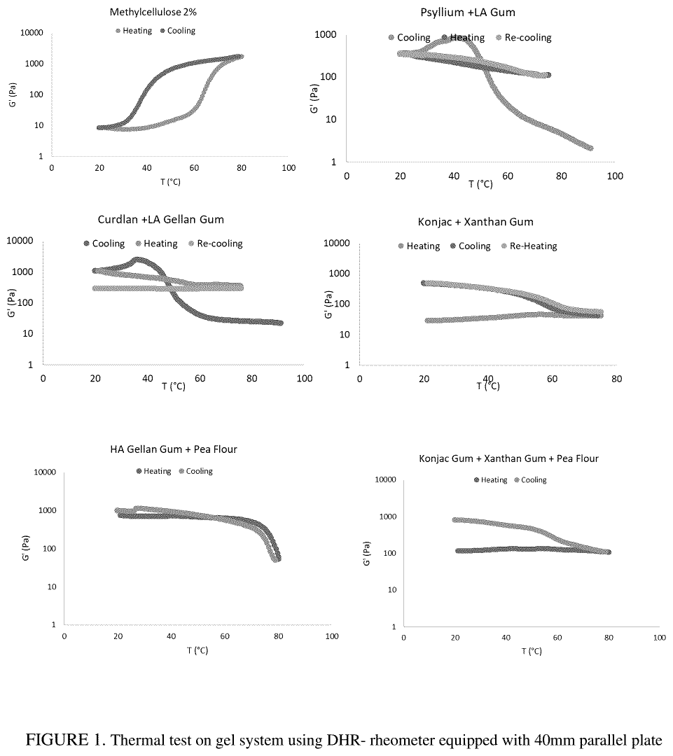

In Combination 1, about 0.5-3% psyllium husk and about 0.1-1% low-acyl gellan gum were used to produce a gel that was heat-stable. Low-acyl gellan gum itself forms a brittle and hard gel at concentrations as low as 0.2%, and a temperature of at least 90° C. is required to hydrate the low-acyl gellan gum. The storage modulus (G′) of the gel would not decrease upon re-heating, indicating an elastic behavior as shown in FIG. 1. Such elastic behavior is useful in meat alternatives to provide a hardness of the texture.

As low-acyl gellan gum itself does not bind well with other dry ingredients, the high water-holding capacity of the psyllium gel is able to trap and hold excess water. However, the psyllium gel itself is not heat-stable, but when the psyllium gel is combined with the low-acyl gum and hydrated with heat at about 90° C., the resultant gel formed upon cooling is strong and has some elasticity. The resultant gel is also heat stable during reheating as shown in FIG. 1 and when incorporated into patties, has a texture similar to that of methylcellulose.

In Combination 2, about 1-3% of curdlan gum and about 0.1-1% of low-acyl gellan gum were used to produce a gel that was heat-stable. The curdlan gum possesses the characteristics of adhesiveness and binding, and is able to form a gel upon heating. Accordingly, Combination 2 was able to form a weak and elastic gel after heating to about 55° C. The gel strength continued to increase during cooling and was heat stable during re-heating.

In Combination 3, about 0.5-3% konjac gum was mixed with about 0.5-2% xanthan gum. Although xanthan gum cannot form a gel by itself, xanthan gum interacts well with water molecules and results in a high viscosity. The konjac gum can form a strong gel upon heating in an alkaline solution with a pH greater than 10. The time and temperature required for gel formation depends on how well heat conduction takes place throughout the gel. For example, a 1 cm gel requires about 10 minutes of heating at 80-90° C. Unlike methylcellulose, konjac gel is heat stable upon cooling. The konjac gum and xanthan gum combination has a synergy that helps the formation of a gel after instant heating. A gel is formed after a 2% solution of the konjac gum and xanthan gum is heated to about 75° C. (which corresponds to a temperature that patties of meat analogs are cooked). The gel formed with the konjac gum and xanthan gum firms during cooling.

In Combination 4, about 0.5-3% konjac gum was mixed with about 0.5-2% xanthan gum and about 1-4% of a pre-gel starch (pea flour). In Combination 5, about 0.5-2% HA gellan was mixed with about 1-4% of a pre-gel starch (pea flour).

FIG. 1 shows the storage modulus (G′) of the gel of each of Combinations 1-5.

Combination 3 is well suited for patty making as no alkaline or heat treatment is needed. Many hydrocolloids require heat treatment to replace methylcellulose to form a gel during patty making. However, most patty production techniques do not use heat. When Combination 3 is used to create a patty, the combination provides texture at ambient temperature that results in patty formation. The cooking of patties formed with Combination 3 promotes the konjac/xanthan gum synergy, and as the patty cools to about 50° C. the konjac/xanthan gum forms a gel and provides the desired texture that a consumer desires in a patty.

Combination 4 provided a nice binding strength for the textured vegetable protein used, as well as elasticity and a juicy bite to resultant burger patty produced with the combination.

When a pre-gel starch (pea flour) was added to the konjac/xanthan blend of Combination 4 and the HA gellan blend of Combination 5, the cohesiveness for easy forming of a patty was increased and the crispiness of the cooked patty was increased. The pre-gel starch also increased the sensory attributes as will be discussed further herein.

TABLE 1
Thermal tests performed on hydrocolloid combinations.

| | MC | Comb. 1 | Comb. 2 | Comb. 3 | Comb. 4 | Comb. 5 |
|---|---|---|---|---|---|---|
| set temp (° C.) | 60 | 60 | 45 | 60 | 60 | 60 |
| Heating | | | | | | |
| G′ at 75° C. (Pa) | 1254.42 | 360.30 | 110.15 | 52.61 | 122.57 | 168.78 |
| Cooling | | | | | | |
| G′ at 55° C. (Pa) | 875.79 | 281.52 | 197.74 | 340.33 | 355.93 | 653.77 |
| G′ at 40° C. (Pa) | 143.74 | 291.77 | 289.76 | 643.42 | 580.2 | 934.13 |

### Example 2. Patty Testing

A plant-based recipe of soy protein, pea protein and/or a combination of both was used as a base formula. To produce the patties, the dry ingredients (i.e., texturized protein, salt, and flavor) were mixed until homogenous, mixed with water to hydrate the texturized protein as known by those of ordinary skill in the art, and allowed to rest for at least about 10 minutes.

Combinations 1, 2, and 3 were evaluated in the patties. For Combinations 1 and 2, the gum blends were each hydrated in 50-60% of the total water of the water used in the patties with an over-head mixer. As the texturized protein was nearing hydration, the gum/water solution was mixed and heated to 90° C. Once the gum solutions were heated, 0.3 M calcium chloride (CaCl₂) was added to the gum solution. Once the calcium chloride was added, the gum/calcium chloride solutions were immediately mixed with the hydrated protein solution and vigorously mixed to uniformly distribute the hydrated gum throughout the hydrated protein. Once the gum solution was thoroughly mixed with the hydrated protein, patties were formed.

For Combination 3, the dry gum blend was dry mixed with the dry ingredients of the patty (i.e., texturized protein, salt, and flavor) and hydrated altogether as known by those of ordinary skill in the art. To help reduce sliminess and/or mouth coating of Combination 3, citrus fiber and/or modified starch can be added to Combination 3 to absorb excess moisture. Once hydrated, the protein/gum solution of Combination 3 was formed into patties.

The patties including the gum blends of Combinations 1, 2, and 3 were all nicely intact and possessed a desirable texture and mouth-feel. The cooked patties including Combinations 1, 2, and 3 were prepared and compared to cook patties including methylcellulose. Patties cooked with each exhibited the following characteristics: methylcellulose, had courser pieces, was very springy, had the taste of firm, fried tofu, and was soft after cooking; Combination 1, texture was very similar to the texture of methylcellulose and had a fibrous structure connecting the protein pieces; Combination 2, the patty was dense and the soy protein pieces were fine; Combination 3, the patty firmed up during cooling, the outside of the patty had a nice crust, but the inside has some undesirable slimy and mouth-coating, however, the addition of the citrus fiber and/or modified starch alleviated this issue.

### Example 3

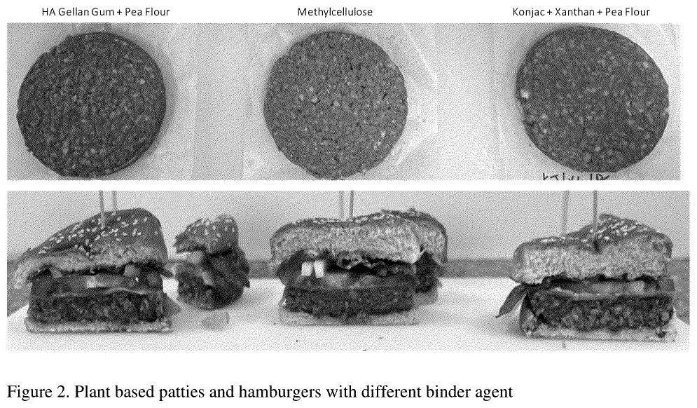

The plant-based patties of FIG. 2 were used to make the hamburgers of FIG. 2 and provided to 6 untrained and unbiased judges at 60° C. The plant-based hamburgers included buns and traditional burger toppings. The 6 judges thought that the methylcellulose based patty tasted like a well-done burger, which was firm and rubbery, and was scored to be the least favorite burger. The patty including 1.25% HA gellan gum and 2% pre-gel starch (pea flour) was the most favorite of the 3 burgers, and was judged to be the most like a real burger with a texture akin to a medium well burger. The patty including the 2% konjac/xanthan (2:1) and 2% pre-gel starch was ranked the second favorite and judged to have the texture of a medium-well burger, but was slightly softer than the HA gellan gum patty.

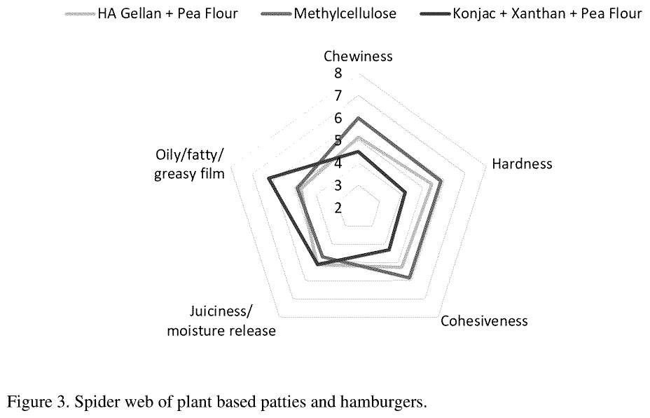

FIG. 3 shows a spider web figure, where a score of 5 was defined as the “ideal burger” for the judges. On a scale of 1-10, the judges ranked the burgers on this example based on their preference.

A shear force test and texture profile analysis are classic instrumental methods for estimating meat tenderness (toughness). The term “shear” refers to sliding of meat parallel to the plane of contact, with the applied force tangential to the segment. It is commonly used in food technology to attribute any cutting action which splits a product into two fragments.

The result of shear test done on patties producing using gels of the present invention shows that the HA Gellan gum+Pea Flour combination gives the highest shear among all the variations and is shown in FIG. 5. The hardness of a methylcellulose-based patty continued to have the highest hardness at 60° C. However, the two clean binder solutions of the present invention had increasing hardness during cool down, while the methylcellulose-based patty became softer.

This disclosure has been described with reference to certain exemplary embodiments, compositions, and uses thereof. However, it will be recognized by those of ordinary skill in the art that various substitutions, modifications, or combinations of any of the exemplary embodiments may be made without departing from the spirit and scope of the disclosure. Thus, the disclosure is not limited by the description of the exemplary embodiments, but rather by the appended claims as originally filed.

1. A method of binding ingredients of a meat alternative product, the method comprising:
mixing a first hydrocolloid and a second hydrocolloid with a protein, thus producing the meat alternative product; and
forming the meat alternative product to a desired shape.

2. The method according to claim 1, further comprising mixing the first hydrocolloid and the second hydrocolloid with water, thus forming a hydrocolloid solution.

3. The method according to claim 1, further comprising mixing the protein with water, thus forming a hydrated protein.

4. The method according to claim 3, wherein the hydrocolloid solution and the hydrated protein are mixed with the water separately, and the hydrocolloid solution and the hydrated protein are mixed together.

5. The method according to claim 2, further comprising heating the hydrocolloid solution.

6. The method according to claim 2, further comprising mixing a cross-linking agent, an oil, a fat, an emulsified oil, an emulsified fat, a fiber, and combinations of any thereof with the hydrocolloid solution.

7-8. (canceled)

9. The method according to claim 1, further comprising mixing the first hydrocolloid, the second hydrocolloid, and the protein with water, thus forming the meat alternative product.

10. The method according to claim 9, further comprising mixing a water binding agent with the first hydrocolloid, the second hydrocolloid, and the protein with water.

11-13. (canceled)

14. The method according to claim 1, wherein the first hydrocolloid and the second hydrocolloid are present in the meat alternative product at an amount of about 1-10%.

15-20. (canceled)

21. A meat alternative product comprising:
a first hydrocolloid;
a second hydrocolloid; and
a plurality of protein particles;
wherein, upon hydration, the first hydrocolloid and the second hydrocolloid adhere at least a portion of the plurality of the protein particles together, and provide structure to the meat alternative product.

22. The meat alternative product of claim 21, wherein the first hydrocolloid and the second hydrocolloid are independently selected from the group consisting of psyllium husk, gellan gum, curdlan gum, xanthan gum, a starch, and combinations of any thereof.

23. The meat alternative product of claim 21, further comprising a cross-linking agent.

24. The meat alternative product of claim 21, further comprising a water binding agent.

25. The meat alternative product of claim 21, wherein the first hydrocolloid and the second hydrocolloid are present in the meat alternative product at an amount of about 1-10%.

26-28. (canceled)

29. A method of binding ingredients of a meat alternative product, the method comprising:
mixing at least one hydrocolloid and a protein, thus producing the meat alternative product; and
hydrating the meat alternative product.

30. The method according to claim 29, wherein the at least one hydrocolloid is present in the meat alternative product in an amount of 1-10%.

31. The method according to claim 29, wherein the at least one hydrocolloid is present in the meat alternative product in an amount of 1-4%.

32. The method according to claim 29, wherein the at least one hydrocolloid comprises a first hydrocolloid and a second hydrocolloid.

33. The method according to claim 29, further comprising forming the hydrated, meat alternative product to a desired shape.

34. The method according to claim 29, further comprising mixing a starch or fiber with the meat alternative product to absorb excess moisture.

35-42. (canceled)
